(19) United States
(12) Patent Application Publication
(10) Pub. No.: US 2005/0248094 A1
(43) Pub. Date: Nov. 10, 2005

(54) Mechanical seal

(76) Inventors: Alan James Roddis, S Yorks (GB); Christopher Newton, Rotherham (GB)

Correspondence Address: MYERS BIGEL SIBLEY & SAJOVEC, PO BOX 37428, RALEIGH, NC, 27627, US

(21) Appl. No.: 11/169,090

(22) Filed: Jun. 28, 2005

Related U.S. Application Data
(62) Division of application No. 10/606,758, filed on Jun. 26, 2003, now abandoned.

(30) Foreign Application Priority Data
Jun. 26, 2002 (GB) GB0214857.5

(51) Int. Cl. F16J 15/34

(52) U.S. Cl. 277/370

(57) ABSTRACT

A mechanical seal 10 provides a fluid tight seal between relatively rotatable elements such as a drive shaft and a housing. The seal includes first and second seal faces (13, 11) and transmission means (27) which engage said second seal face and extend axially therefrom in a direction away from said first seal face. Biasing means (28) bias the transmission means, and thereby the second seal face, towards the first seal face. Drive means (29) engage the transmission means and are for mounting in driving engagement with the second element. The drive means include at least one radially extending engagement portion (30) which extends into an axially enclosed opening (31) in the transmission means.

### FIELD OF THE INVENTION

The invention relates to mechanical seals, more particularly to the drive and coupling arrangements within mechanical seals.

### BACKGROUND OF THE INVENTION

A mechanical seal comprises a “floating” component which is mounted axially movably around the rotary shaft of, for example, a pump and a “static” component which is axially fixed, typically being secured to a housing. The floating component has a flat annular end face, i.e. its seal face, directed towards a complementary seal face of the static component. The floating component is urged towards the static component to close the seal faces together to form a sliding face seal, usually by means of one or more spring members. In use, one of the floating and static components rotates; this component is therefore referred to as the rotary component. The other of the floating and static components does not rotate and is referred to as the stationary component.

Those seals whose floating component is rotary are described as rotary seals. If the floating component is stationary, the seal is referred to as a stationary seal.

If the sliding seal between the rotary and stationary components are assembled and pre-set prior to despatch from the mechanical seal manufacturing premises, the industry terminology for this is “cartridge seal”. If the rotary and stationary components are despatched individually (unassembled) from the mechanical seal manufacturing premises, the industry terminology for this is “component seal”.

Mechanical seals are used in all types of industries to seal a variety of different process media and operating conditions. The general industry term which defines the area adjacent to the process media is “inboard”. The industry term which defines the area adjacent to the atmospheric side is “outboard”.

Like most industries, the mechanical seal industry is highly competitive. As a result, mechanical seal manufacturers constantly seek methods of improving competitive advantage. Pressed and formed components are one way in which mechanical seal manufacturers can reduce the manufacturing cost of said component.

Unfortunately pressed components can compromise the technical aspects of a single component or a combination of components working relative to each other. One such example of this is the drive mechanism between two components working relative to each other. As pressed components are manufactured from a given thickness of material, the cross-sectional area of the drive mechanism is traditionally thereby limited to a multiplication of said thickness.

Pressed components are typically manufactured from sheet material, typically steel or stainless steel with a material thickness of 0.2 mm to 2.5 mm. Most mechanical seal components are pressed using 1.2 mm to 1.7 mm thick material. Pressed components offer the advantage that, in most cases, subsequent machining operations are not necessary. This therefore reduces the manufacturing cost considerably.

### STATEMENTS OF THE INVENTION

According to the present invention there is provided a mechanical seal for providing a fluid-tight seal between relatively rotatable elements, the seal comprising first and second seal faces for mounting ill fixed rotational relationship with respective first and second relatively rotatable elements, transmission means engaging said second seal face and extending axially therefrom in a direction away from said first seal face, means for biasing said transmission means, and thereby said second seal face, towards said first seal face, and drive means engaging said transmission means and for mounting in driving engagement with said second element, said drive means including at least one radically extending engagement portion which extends into an axially enclosed opening in said transmission means.

Preferably the drive means includes at least two radially extending engagement portions and said transmission means includes at least two corresponding enclosed openings within which said engagement portions locate.

Preferably the arrangement is such that rotational drive is transmitted from said drive means to said transmission means over a cross-sectional engagement area which is larger than the sum of the respective material thicknesses of said drive means and said transmission means.

Preferably a mechanical seal of the invention includes two engagement portions the seal being assembled by locating at least one engagement portion of said drive means in an enclosed opening of said transmission means, thereafter pivoting said drive means relative to the transmission means such that the outermost radial part of a second engagement portion on the drives means is an interference fit with the innermost radial part of the transmission means adjacent to that enclosed opening for accommodating the second engagement portion. More preferably the axial end of the second enclosed slot of the transmission means terminates within close proximity of the axial end of said transmission means to provide a thin section web which elastically deforms when presented to the interference fit of the engagement portion of said drive means.

Preferably a seal in accordance with the present invention has drive means and transmissions means are made of one or more thin material.

Alternatively the drive means may be made from relatively thin material and said engagement portions provided by a machined lug. Furthermore the transmission means may be made from relatively thick material.

A mechanical seal in accordance with the present invention may be in the form of a single component mechanical seal, a single cartridge mechanical seal or another form of mechanical seal.

### BRIEF DESCRIPTION OF THE DRAWINGS

The accompanying drawings are as follows:

FIG. 1 is a cross-sectional view of a prior art single component mechanical seal;

FIG. 2 is a isometric view showing the staking operation conducted after the assembly of two components of the seal of FIG. 1;

FIG. 2b is an enlarged partial cross-section of the arrangement shown in FIG. 2;

FIG. 2c is an enlarged isometric view of part of the arrangement of FIG. 2;

FIG. 3 is a cross-sectional view part of a single rotary mechanical seal of the invention;

FIG. 3b is a partial cross-sectional view of the entire mechanical seal of FIG. 3;

FIG. 4 shows cross-sectional and plan view of two of the components of the seal of FIG. 3;

FIG. 5 is an isometric view of the components shown in FIG. 4;

FIG. 6 is an exploded isometric view of the components of FIG. 5;

FIG. 7 shows further cross-sectional and plan views of the components of FIG. 4;

FIG. 8 shows cross-sectional and plan views of alternative components similar to those shown in FIG. 4; and

FIG. 9 is a partial cross-sectional view of a single cartridge seal of the invention.

### DETAILED DESCRIPTION OF THE INVENTION

The invention will now be described, by way of examples only, with reference to the accompanying drawings.

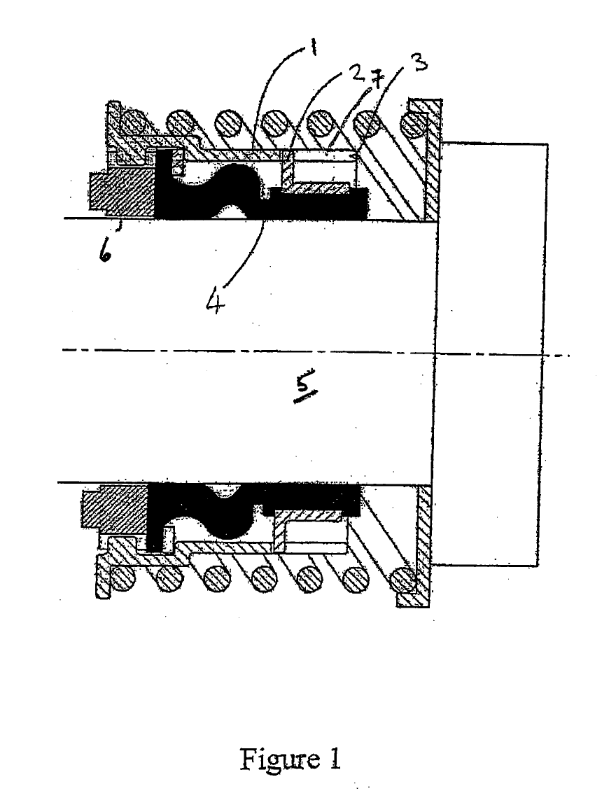

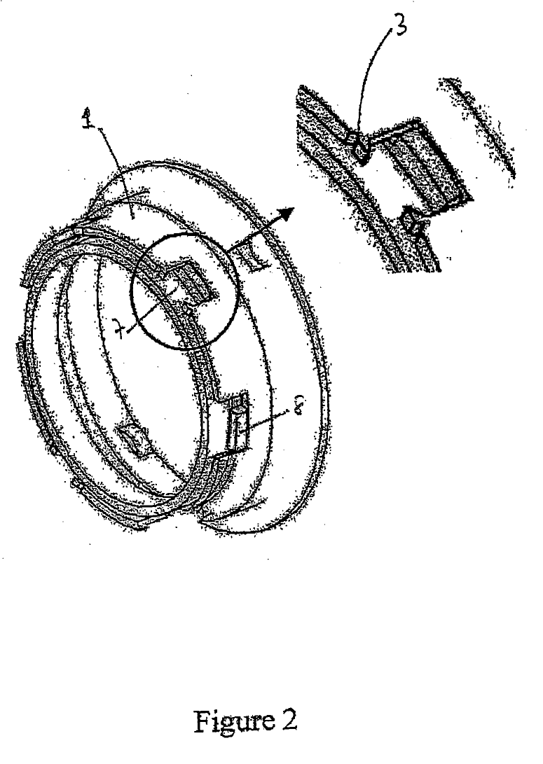

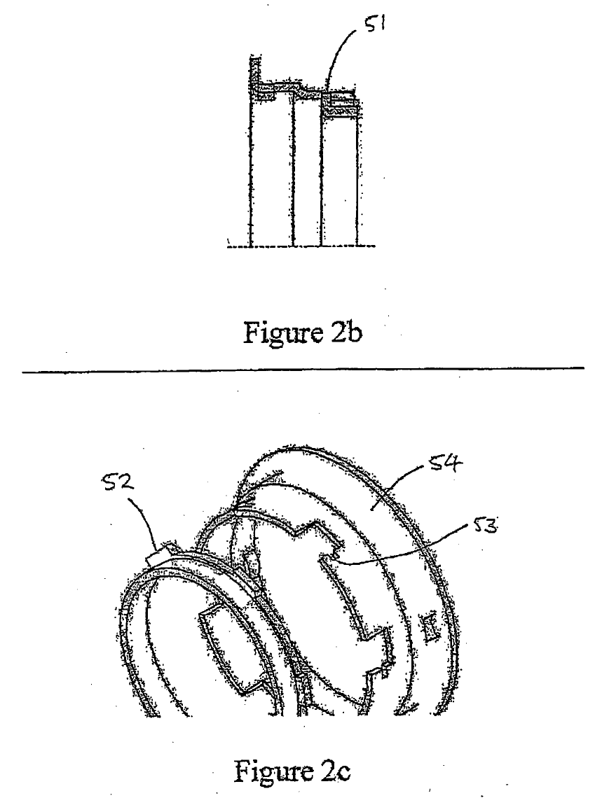

The prior art single component mechanical seal partially shown in FIGS. 1 and 2 includes a rotary holder 1, a drive plate 2 and rubber bellows 4. The rotation of the drive shaft 5 is transmitted to seal face 6 through rubber bellows 4, drive plate 2 and rotary holder 1. Rotary holder 1 includes circumferentially spaced apart slots 7 within which upstanding lugs 8 of rotary holder locate.

In order to keep rotary holder 1 and drive plate 2 from disconnecting, the entrance corners of slots 7 are staked, as indicated at 3. The staking operation is typically conducted using a hammer and a sharp implements such as a chisel. This staking operation is a manual process and, as a result, the results are somewhat variable, the variation ranging from a particularly deep-staked impression to no staking at all due to a manual error.

The staking operation creates a sharp raised surface in rotary holder 1. This surface can damage other components such as the rubber bellows 4. Furthermore, the sharp surface can result in injury to personnel.

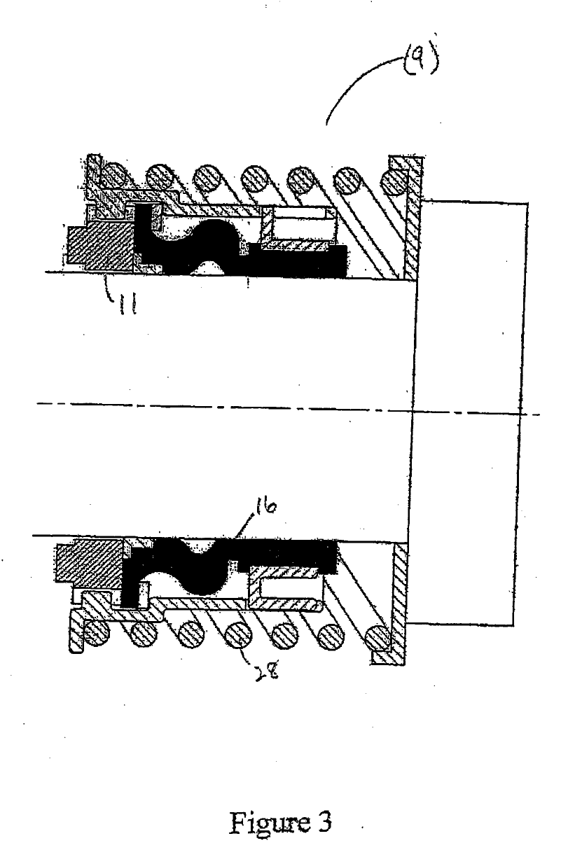

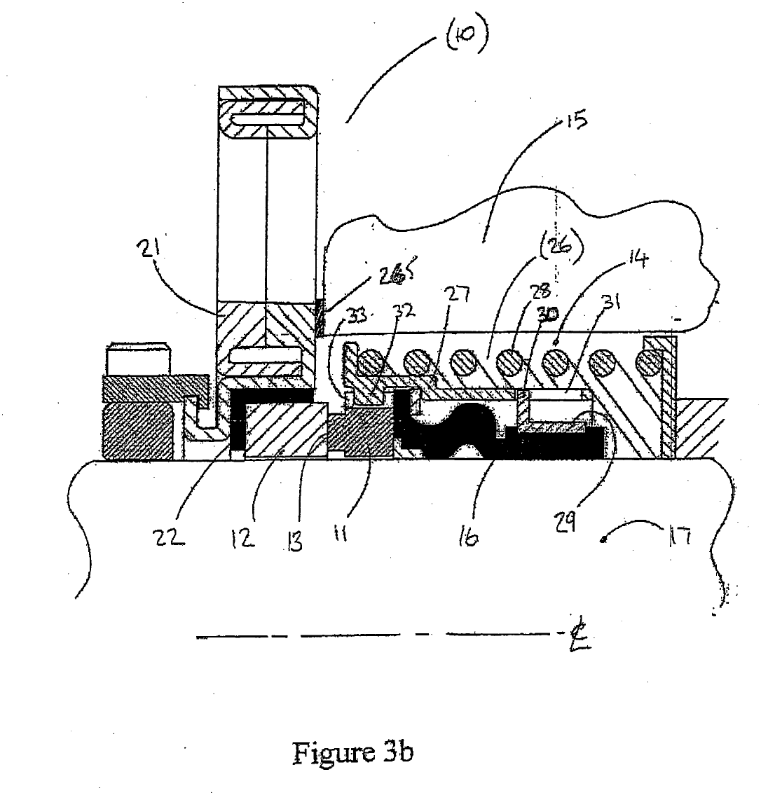

Referring to FIG. 3 of the accompanying drawing, a rotary mechanical seal 9 of the invention includes a rotary and axially floating seal face 11 which is biased by spring 28 towards a static stationary seal face 12. The rotary seal face 11 is allowed to slide on the static seal face 12 and the interface between the rotary seal face 11 and stationary seal face 12 forms sealing area 13. This seal area 13 is the primary seal that prevents the process medium 14 from escaping from the process chamber 15.

In addition to the sliding seal face, the process medium 14 is sealed by a rotary elastomeric member 16 in contact with the shaft 17 and rotary seal face 11. This is the first secondary sealing area. The second secondary sealing area is formed between the stationary seal face 12 and the stationary gland plate assembly 21 by means of elastomeric member 22. The third secondary sealing area is formed between the gland plate assembly 21 and the process chamber 15 by means of gasket 25.

The three secondary sealing areas and the primary sliding sealing interface prevent the process media 14 from escaping from the process chamber 15.

The static seal face 12 is prevented from rotating by radial squeeze between the elastomeric member 22 and the gland plate assembly 21. An additional or alternative anti-rotation device can be incorporated if it is considered desirable.

The rotary sealing assembly 26 Includes a rotary holder 27 which is a pressed metal device and which transmits the axial force spring 28 to the seal face 11.

A drive ring 29 is fitted to the radially outward portion of elastomeric member 16. This drive ring 29 radially compresses elastomeric member 16 to form a seal to the shaft 17.

The rotational movement of shaft 17 is transmitted through the elastomeric member 16 to drive ring 29. Drive ring 29 in turn transmits the rotational movement to the rotary holder 27 by means of drive lugs 30 circumferentially spaced apart around drive ring 29. At least one of these drive lugs 30 engages in a axially enclosed slot 31 in rotary holder 27. Other drive lugs 30 may engage in either axially enclosed slots or axially open slots such as those shown in the prior art seal of FIGS. 1 and 2.

The rotary holder 27 transmits the rotation movement to the seal face 11 by means of drive lugs 30 which extend into and engage in slots 33 located in the seal face 11.

In alternative embodiments the drive mechanism may be varied from that described above. For example an alternative drive mechanism may include a pin in the slot arrangement.

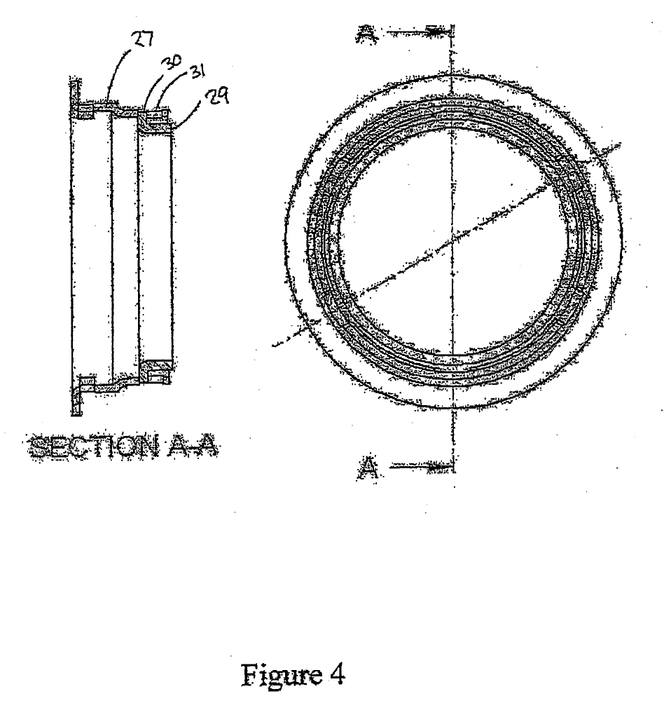

Referring to FIG. 4 of the accompanying drawings, the rotary holder 27 and drive plate 29 are shown in their working position. The drive plate 29 is axially captured in rotary holder 27 because at least one drive lug 30 of drive plate 29 is located in a corresponding enclosed slot 31 of the holder 27. Accordingly drive plate 29 cannot become decoupled from rotary holder 27. This is of particular advantage in certain applications such as those creating reduced pressure or vacuum conditions in the process chamber 15. Furthermore, during installation of the seal, the rotary seal assembly 26 is often pushed, pulled and rotated as it is fitted to the shaft 17. If the driver in 29 is not axially retained relative to the rotary holder 27, the rotary assembly 26 can fall apart.

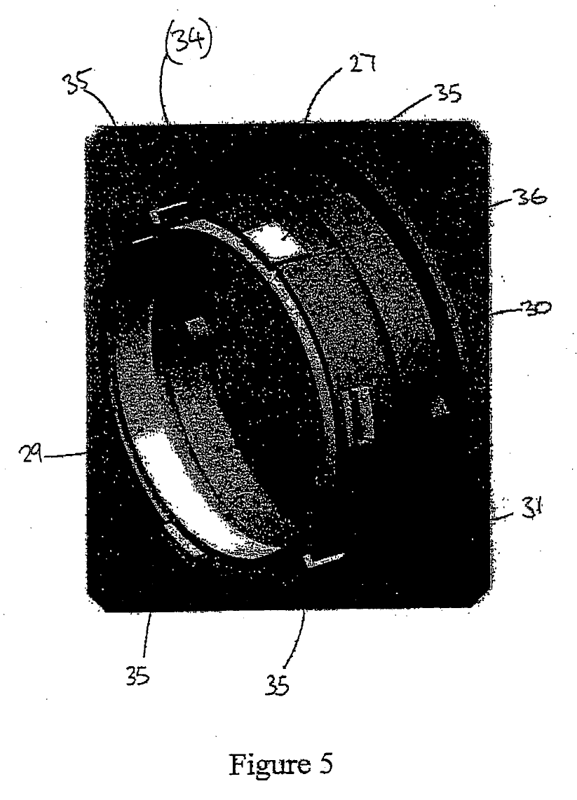

Referring to FIG. 5 of the accompanying drawings, it can be seen or appreciated that, while four drive lugs 35 engage in open slots 31 in the rotary holder, two drive lugs 30 engage in enclosed slots 31. It will be appreciated that any number and combination of open slots 36 and closed slots 31 can be incorporated in a rotary holder 27.

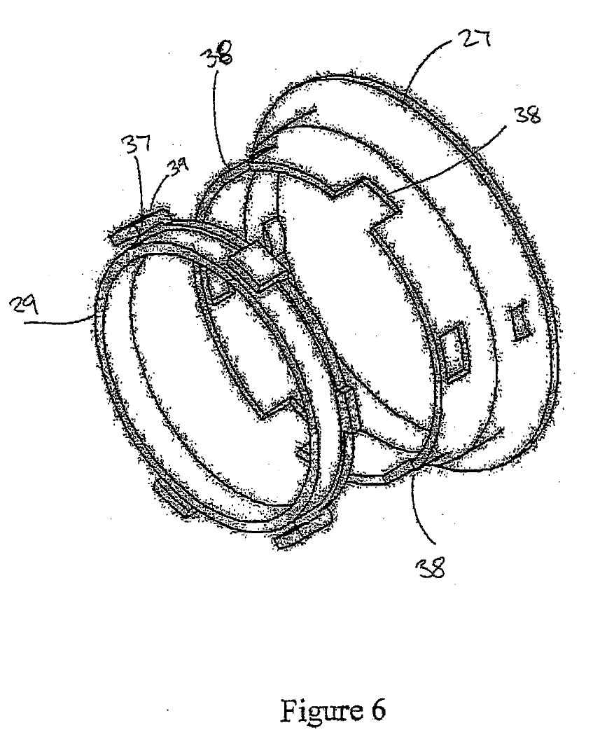

Referring to FIG. 6 of the accompany drawings, it is seen more clearly that the drive plate 29 includes a plurality of lugs 37 which have a radially outwardly extending portion of which subsequently return in an axial direction. These lugs 37 correspond to slots 38 in the rotary holder 27. The axial return 39 of each lug 37 coincides with the radial position of a corresponding slot 38 in the rotary holder 27.

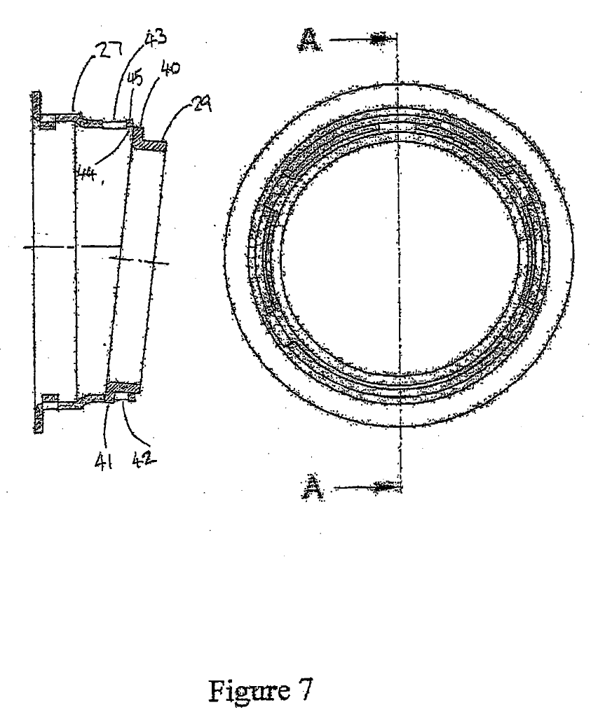

Referring to FIG. 7 of the accompanying drawings, the drive plate 29 includes two drive lugs 40 and 41 which extend radially outwardly over a restricted circumferential extent.

During assembly of the rotary holder 27 and drive plate 29, the drive lug 41 is located in an enclosed slot 42 with the result that the drive ring 29 is then radially off-centre to the rotary holder 27. The drive ring 29 is then pivoted about the area of engagement of the drive lug 41 and enclosed slot 42, until the second drive lug 40 locates in the second enclosed slot 43.

The driver ring 29 is slightly radially larger than the corresponding inner surface 44 of the rotary holder 27 in that area adjacent to the second enclosed slot 43. This results in a radial interference during the above mentioned pivoting movement, thereby allowing the drive ring 29 to click into position as a result of the web 45 of enclosed slot 43 elastically deforming radially to accommodate the interference. This deformation is not permanent and the web 45 returns to its original confirmation once the lug 40 has located into slot 43.

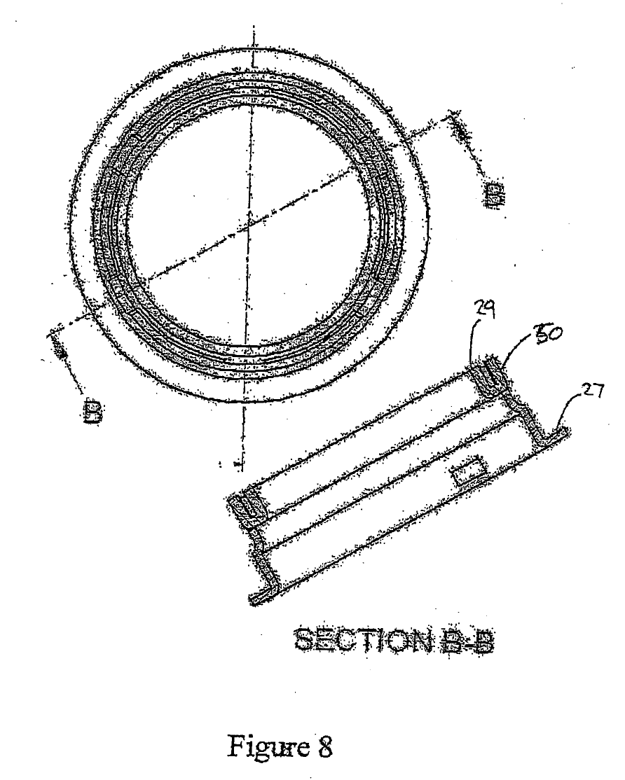

Referring to FIG. 8 of the accompanying drawings, there is illustrated a partial enlarged cross-sectional view of a rotary holder 27 and drive plate 29. The drive cross-sectional area 50 is considerably increased when compared to the cross-sectional area 51 of the prior art arrangement illustrated if FIG. 2b. This increase in cross-sectional drive helps to prevent the drive plate 52 (see FIG. 2c) wearing the rotary holder 54 at 53. This reduction or elimination of wear results from the same rotational force, derived from the drive torque, being spread over a larger cross-sectional area 50 (FIG. 8) compared to that of the FIG. 2c arrangement, even though the same thickness of pressed material is employed in both arrangements. Accordingly, the invention helps to improve mechanical seal life.

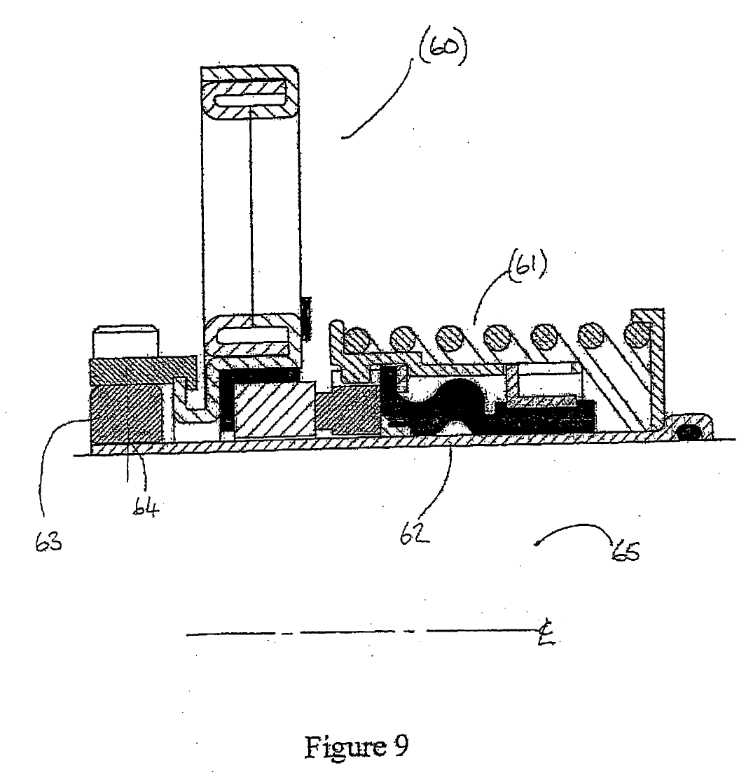

Referring to FIG. 9 of the accompanying drawings, there is illustrated a single cartridge mechanical seal 60 in accordance with the invention. The rotary assembly 61 is identical to that described above. The seal shown in FIG. 9 includes a sleeve 62 which connects the rotary assembly 61 with a clamp ring 63. Clamp ring 63 contains at least one screw 64 for connecting the rotating parts of the cartridge mechanical seal 60 to the shaft 65.

It should be appreciated that the present invention may be applied to both rotary and stationary seals whether of single, double or triple seal type and whether designed in a cartridge or component seal format.

The invention may be used with metallic components as well as non-metallic components such as plastic. Furthermore some types of equipment rotate the housing and have a stationary shaft. The invention can be applied to such an arrangement.

1. A mechanical seal for providing a fluid-tight seal between relatively rotatable elements, comprising.
first and second seal faces for mounting in fixed rotational relationship with respective first and second relatively rotatable elements;
transmission means engaging said second seal face and extending axially therefrom in a direction away from said first seal face;
means for biasing said transmission means, and thereby said second seal face, towards said first seal face; and
drive means engaging said transmission means and for mounting in driving engagement with said second element, said drive means including at least one radially extending engagement portion which extends into an axially enclosed opening in said transmission means, said drive means further comprising at least one radially extending engagement portion having a cross-sectional engagement area which is larger than the sum of the respective material thickness of said drive means and said transmission means.

2. A mechanical seal according to claim 1 wherein said drive means comprises at least two radially extending engagement portions and said transmission means comprises at least two corresponding enclosed openings within which said engagement portions locate.

3. (canceled)

4. A mechanical seal according to claim 1 wherein said drive means comprises at least two engagement portions, at least one engagement portion of said drive means being located in an enclosed opening of said transmission means, thereafter pivoting said drive means relative to the transmission means such that the outermost radial part of a second engagement portion of the drive means is an interference fit with the innermost radial part of the transmission means adjacent to the enclosed opening for accommodating the second engagement portion.

5. A mechanical seal according to claim 4 wherein an axial end of a second enclosed slot of the transmission means terminates within close proximity of an axial end of said transmission means to provide a thin section web which elastically deforms when presented to the interference fit of the second engagement portion of said drive means.

6. A mechanical seal according to claim 1 wherein said drive means and said transmission means are made of one or more thin materials.

7. A mechanical seal according claim 4 wherein said drive means is made from relatively thick material and said drive means engagement portions are provided by a machined lug.

8. A mechanical seal assembly according to claim 1 wherein said transmission means is made from relatively thick material.

9. A mechanical seal according to claim 1 wherein said mechanical seal is in the form of a single component mechanical seal.

10. A mechanical seal according to claim 1 wherein said mechanical seal is in the form of a single cartridge mechanical seal.

11. (canceled)

12. (canceled)
